(19) United States
(12) Patent Application Publication
(10) Pub. No.: US 2006/0115204 A1
(43) Pub. Date: Jun. 1, 2006

(54) Distributed Temperature Sensing System with Remote Reference Coil

(75) Inventors: Richard Marsh, Southampton (GB); Arthur H. Hartog, Southampton (GB); Garth Naldrett, Southampton (GB); Vladimir Vaynshteyn, Sugar Land, TX (US)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, Sugar Land, TX (US)

(21) Appl. No.: 11/164,291

(22) Filed: Nov. 17, 2005

(30) Foreign Application Priority Data
Apr. 27, 2004 (WO) PCT/GB04/01792

(51) Int. Cl. G02B 6/00

(52) U.S. Cl. 385/12

(57) ABSTRACT

The invention is an optical fiber distributed temperature sensing system comprising an opto-electronic unit and a sensing optical fiber, which system measures temperature so as to provide a temperature profile along at least part of the length of the optical fiber. The system includes reference coils, which are temperature reference points, at a location that is remote from the opto-electronic unit and closer to the region whose temperature is being measured.

### BACKGROUND OF THE INVENTION

1. Field of the Invention

The invention generally relates to optical fiber distributed temperature sensing systems (“DTS”). More particularly, the invention relates to improvements that enable such systems to be deployed and utilized in long lengths or with multiple connectors, such as within oil and gas wells including subsea wells.

2. Description of Related Art

There are a number of applications of DTS where the instrument must be sited a long way from the section of fiber to be measured, but where only a relatively short (in relation to the distance to the DTS instrument, whether measured in units of length or, more importantly in units of attenuation of the light) piece of fiber at the remote end needs to be measured.

The preferred configuration for a DTS is in double-ended mode, where the fiber is looped back to the instrument. The measurement is made successively from one end and then the other. The data from the two ends are combined to eliminate the losses accurately and leave only that information which relates to temperature. DTS instrumentation is based on the principle of measuring the backscattered light returning as a function of position in the fiber. In general, backscatter at several wavelengths is measured and the data at these wavelengths is again used to reduce the effect of losses in the fiber. One design involves using the anti-Stokes/Stokes Raman ratio, which yields a signal that is temperature dependent but also contains a residual sensitivity to the differential losses between the wavelengths used. The double-ended method is then used to eliminate the residual loss dependency. In order to eliminate the (generally unknown) losses through the optical paths at the various wavelengths within the instrumentation, it is common for a section of fiber (or a section at each end of the fiber) to be held at a constant, or at least known, temperature. These fiber sections are known as “reference coils.” The temperature of each point along the fiber is related to that in the reference coil by comparing (in the simplest case by taking their ratios) the signal intensities in the reference coils to those at the point of interest.

There are alternative means of eliminating the effects of differential losses along the fiber that are applicable to single-ended systems. The present application applies equally to single-ended operation.

There are applications of DTS where the losses in the optical fiber, or fiber loop, are very large, but where only a section of fiber, which is remote from the instrumentation, is of interest. One such application is the measurement of the temperature profile in an oil well, where in general, only the section of well across the reservoir is of interest. The length of fiber from the instrument to the wellhead and from the wellhead to the oil-producing zones is of little interest. Of special importance is the accumulation of optical losses arising not only from propagation through the fiber in the upper sections of the well, but also from the connectors used to interconnect the optical path through the wellhead and to the cable in the upper section of the well.

Another example is in the measurement of the surface temperature of process vessels (such as a pressure or other industrial vessel), where the DTS instrument might be sited remotely in a control room some distance from the vessel (often situated in a hazardous area) and is connected to the fiber on the process vessel through a connecting optical cable which can be of significant length.

In some of these cases the ability of the DTS to measure the temperature of the section of fiber of interest is limited not by the signal to noise ratio in the remote section, but by the total losses around the loop in the case of double-ended measurements or to the section of interest in the case of single-ended systems and the resulting requirements on the dynamic range of the acquisition electronics.

Thus, there exists a continuing need for an arrangement and/or technique that addresses one or more of the problems that are stated above.

### BRIEF SUMMARY OF THE INVENTION

The invention is an optical fiber distributed temperature sensing system comprising an opto-electronic unit and a sensing optical fiber, which system measures temperature so as to provide a temperature profile along at least part of the length of the optical fiber. The system includes reference coils, which are temperature reference points, at a location that is remote from the opto-electronic unit and closer to the region whose temperature is being measured.

Advantages and other features of the invention will become apparent from the following description, drawings, and claims.

### BRIEF DESCRIPTION OF THE DRAWINGS

FIG. 1 is a schematic of a prior art DTS with the reference coils located internal or proximate to the DTS instrument.

FIG. 2 is a schematic of one embodiment of the present invention in which the optical fiber is in a looped configuration and the reference coils are located remotely from the DTS instrument.

FIG. 3 is a schematic of another embodiment of the present invention in which the optical fiber is in a single-ended configuration, the reference coil is located remotely from the DTS instrument, and the temperature of the reference coil is measured with an independent sensor.

FIG. 4 is a schematic of another embodiment of the present invention in which the optical fiber is in a single-ended configuration, the reference coil is located remotely from the DTS instrument, and the temperature of the reference coil is measured with an independent optical fiber.

FIG. 5 is a schematic of the present invention used in an oil and gas well in a single-ended configuration.

FIG. 6 is a schematic of the present invention used in an oil and gas well in a looped configuration.

FIG. 7 is a schematic of the present invention used in a pipeline application.

FIG. 8 is a schematic of the present invention used in an oil and gas well in a single-ended configuration and with the reference coil located between the DTS instrument and the wellhead.

FIG. 9 is a schematic of the present invention used in an industrial vessel application.

FIG. 10 is a schematic of an embodiment of the present invention in which multiple reference coils are used to divide the optical fiber into multiple regions of interest.

### DETAILED DESCRIPTION OF THE INVENTION

FIG. 1 shows a generic prior art application of a DTS 10. DTS optical fiber 14 is functionally connected to the DTS instrumentation 12 and extends towards a remote measurement location 16. The fiber section of interest 18 extends through or into the remote measurement location 16 in order to provide the required measurement. FIG. 1 shows a looped configuration in which the optical fiber 14 loops back from the measurement location 16 (or region of interest) to the DTS instrumentation 12.

DTS 10 comprises a distributed temperature sensor that measures the temperature profile along the optical fiber 14, and particularly along the region of interest 16. In one embodiment, DTS 10 comprises an optical time domain reflectometry (OTDR) system, such as those described in U.S. Pat. Nos. 4,823,166 and 5,592,282, both of which are incorporated herein by reference. In OTDR, a pulse of optical energy is launched into an optical fiber and the backscattered optical energy returning from the fiber is observed as a function of time, which is proportional to distance along the fiber from which the backscattered light is received. This backscattered light includes the Rayleigh, Brillouin, and Raman spectrums. The Raman spectrum is the most temperature sensitive, with the intensity of the spectrum varying with temperature, although Brillouin scattering, and in certain cases Rayleigh scattering, are temperature sensitive.

Generally, in one embodiment, pulses of light at a fixed wavelength are transmitted from a light source in the DTS instrumentation 12 down the optical fiber 14. Light is backscattered along the length of the optical fiber 14 and returns to the DTS instrumentation 12. Knowing the speed of light and the moment of arrival of the return signal enables its point of origin along the optical fiber 14 to be determined. Temperature stimulates the energy levels of molecules of the silica and of other index-modifying additives—such as germania—present in the optical fiber 14. The backscattered light contains upshifted and downshifted wavebands (such as the Stokes Raman and Anti-Stokes Raman portions of the backscattered spectrum) that may be analyzed to determine the temperature at origin. In this way, the temperature along the optical fiber 14 can be calculated by the DTS instrumentation 12, providing a complete temperature profile along the length of the optical fiber 14.

As previously disclosed, in order to eliminate the generally unknown losses through the optical paths at the various wavelengths within the instrumentation 12, it is common for a section of optical fiber 14 (such as the section at the end of optical fiber 14) to be held at a constant or known temperature. These known temperature measurement locations are referred to as reference coils. The reference coils 20 in the prior art are located at or proximate to the DTS instrumentation 12 and remotely from the measurement location 16.

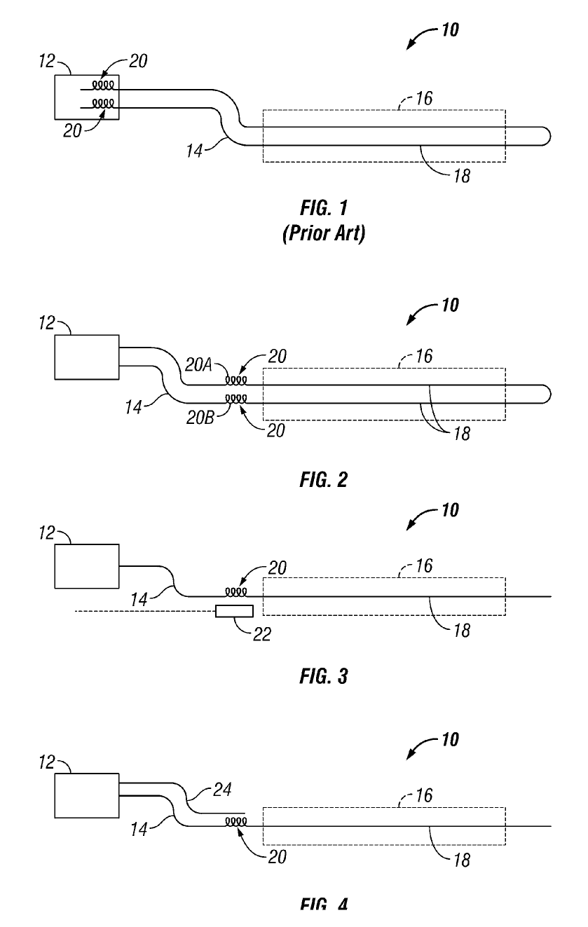

As shown in FIG. 2 in relation to a generic application, the present invention comprises locating the reference coils 20 of the DTS 10 remotely from the DTS instrumentation 12. In the present invention, the reference coils 20 are located in a region closer to the fiber section of interest 18 and the measurement location 16.

In order to act as an accurate reference, the true temperature of the reference coils 20 must be known. Therefore, it is necessary to provide a way to obtain the temperature of the remote reference coils 20. This temperature measurement may be provided using different techniques, including using a local and/or independent sensor 22 (see FIG. 3) which may be an optical or electronic sensor (among others), using a separate optical fiber 24 connected to the DTS instrumentation 12 but designed to reach just the remote reference coil 20 (see FIG. 4), or using the DTS instrumentation 12 on the same optical fiber 14 but using a different electronic gain (and possibly optical input pulse energy) for the measurement from the instrumentation 12 to the remote reference coil 20. The temperature at the reference coils may also be obtained from a thermal model used to calculate the temperature at point 20 from a temperature measured at a distant point.

A number of optical connectors are sometimes required between the measurement location 16 and the DTS instrumentation 12. The format, type, and position of these connectors may vary according to the application of the DTS 10. However, the distance and optical attenuation between the measurement location 16 and instrumentation 12 could be substantial. The optical path used for measurement of the measurement location 16 could be a single optical fiber 14 from the DTS instrumentation 12 to the end of the measurement location 16 as shown in FIG. 3, or a double-ended configuration where the optical fiber 14 is looped at the measurement location 16 back to DTS instrumentation 12 as shown in FIG. 2. The measurement location 16 may have relatively low optical attenuation when compared with the attenuation of the connectors along with the attenuation of the optical path to the measurement location 16. The length of measurement in the measurement location 16 may also be small compared to the distance of the DTS instrumentation 12 from this location 16.

Because the attenuation in the measurement location 16 is relatively small, the dynamic range of the measured signal is smaller than would be required if monitoring the full loop (in the double-ended configuration of FIG. 2). This allows the DTS to be optimized for readings with similar signal strength.

With the described system configuration, the temperature of the reference coil 20 is kept close to the temperature of the measurement location 16. This allows scaling errors in the observed temperature to be kept small. Any temperature change measured will more accurately represent the actual temperature differential than would be the case if there were large differences between the reference coil 20 temperature and the temperature at the measurement location 16. In other words, the effect of any drift of the DTS instrumentation 12 sensitivity will not be as great on the output measurement of the DTS instrumentation 12 (when compared to a system in which the reference coil is located at or proximate the DTS instrumentation).

A significant advantage of the present invention is a shorter optical path (with lower attenuation) in the double-ended configuration (FIG. 2). In the double-ended system backscattering is only measured from the first reference coil 20A, down through the measurement location 16 and back up the fiber to the second reference coil 20B. System losses are now therefore only based on losses from the DTS instrumentation 12 through the first reference coil 20A and to the top of the second reference coil 20B. Losses from the second reference coil 20B back to the DTS instrumentation 12 are not included in the calculation of system loss, as would be the case if the reference coils 20 were located in or proximate to the DTS instrumentation 12. Thus, the optical power sent through the optical fiber 14 may be raised without saturating the relevant receiver in the DTS instrumentation 12 and the gain may also be raised without saturating the analog to digital converter in the DTS instrumentation 12.

The remote location of the reference coils 20 therefore provides various benefits, including:

1. allowing the optical signals and the DTS instrumentation 12 electronic signals to be increased in intensity for those regions upstream of the reference coil(s) 20 which are not of interest, which allows the dynamic range of the instrumentation 12 to be far better utilised;

2. allowing the range of signal levels to be reduced; and

3. in the double-ended DTS configuration (see FIG. 2), while the losses in the optical fiber 14 from the instrumentation 12 to the first reference coil 20A affect the measurement performance, those from the second reference coil 20B back to the instrumentation 12 do not. In certain configurations, the optical power budget is thereby significantly improved.

Although referred to and illustrated as “reference coils,” the sections of optical fiber 14 comprising the coils 20 need not be in a coiled configuration. Specifically, in the case in which the temperature is fairly stable and known along a linear length, such sections of optical fiber 14 may also be linear in configuration.

In another embodiment as shown in FIG. 10, multiple reference coils 20 may be used in order to split the optical fiber 14 into multiple measurement locations 16. The DTS instrumentation 12 in this embodiment focuses its dynamic range and processing power to each of the multiple measurement locations 16 and not the intervals therebetween.

The present invention can be used in a variety of applications, including within an oil and gas well, on an industrial process vessel, along pipelines, or along an electrical power cable. Some of these applications will be explained and further described below.

Application 1

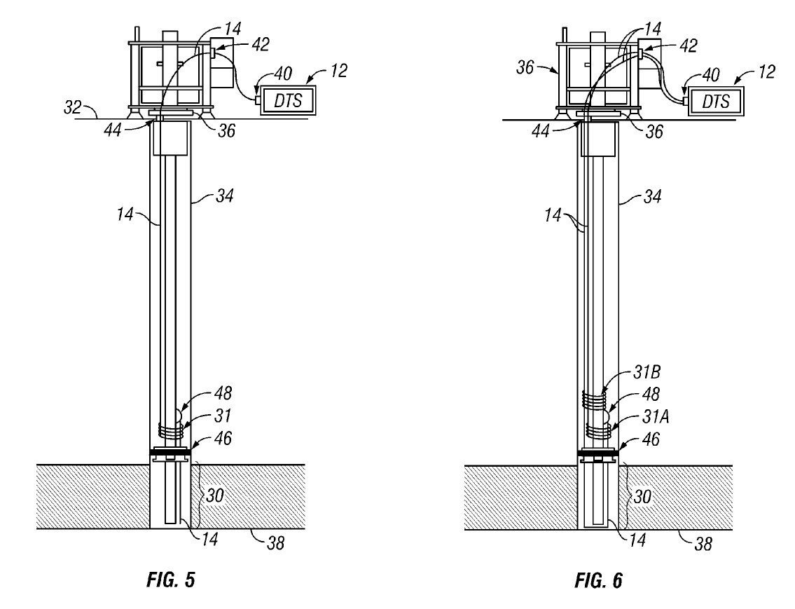

In a typical oil and gas DTS application as shown in FIG. 5, a DTS instrument 12 is located at the surface 32 of a wellbore 34, which may be cased or uncased. An optical fiber 14 extends from the instrument 12, through the wellhead 36, into the wellbore 34, and towards the region of interest 30 (the measurement location 16). The region of interest 30 may comprise at least one formation 38 into which fluids are injected or from which fluids are recovered and produced. In one embodiment, the reference coil(s) 31 may be located within the wellbore 34 and proximate the region of interest 30.

The wellbore 34 may be a subsea wellbore, wherein the surface 32 of the wellbore 34 is the ocean floor. In subsea wellbores, the instrument 12 may be located at the surface 32 (ocean bottom), at the ocean surface within a specialized container such as an instrumented buoy, on a floating production vessel, or on a platform.

Typically, a number of optical connectors are required between the region of interest 30 and the DTS instrumentation 12. The format, type, and position of these connectors may vary according to the design of the wellbore and included completion system. For instance, in a subsea wellbore wherein the instrumentation 12 is located at the surface 32, the connectors would normally include at least an active base connector 40, an ROV connector 42 (which would enable the connection of an ROV to the instrumentation 12 in order to remotely obtain the DTS data), and a tubing hanger connector 44.

The distance between the subsea wellhead 36 and instrumentation 12 could be a number of meters or a number of kilometers if located in a central subsea location or on surface. A single instrument may interrogate a single well, or a number of wells with their respective downhole reference coil(s) 31.

The optical path used for measurement of the region of interest 30 may be a single optical fiber 14 from the DTS instrumentation 12 to the bottom of the well as shown in FIG. 5, or a double-ended configuration where the optical fiber 14 is looped at the region of interest 30 back to surface 32 as shown in FIG. 6. The optical path may also be in a J configuration (not shown) with a fiber from the DTS instrumentation 12 to the bottom of the well and back to a reference coil, but the fiber does not return to the instrumentation.

The region of interest 30, which can be located below a production packer 46, has a relatively low optical attenuation when compared with the attenuation of the connectors along with the attenuation of the optical path to the region of interest 30. The length of measurement in the region of interest 30 is also small compared to the distance between the DTS instrumentation 12 and the region of interest 30.

Although FIGS. 5 and 6 show a simple well completion for the purpose of clarity, additional downhole equipment may be present according to well production requirements. This equipment may include a downhole fiber optic connector either above or below a point of reference temperature measurement 48. The reference temperature measurement 48 is a separate measurement of temperature proximate the reference coils 31 so that the reference coils may act as a true reference to the system. The reference temperature measurement 48 may be made by a separate temperature gauge (such as an electrical gauge), by fiber temperature measurement, or by a modeled temperature point. The reference temperature measurement techniques described in relation to FIGS. 2-4 may also be used. By making use of the downhole reference temperature measurement 48, accurate tracking of reference coil 31 temperature is possible.

It is possible that the temperature at the reference coils 31 may not be available from a discrete temperature measurement device. However, a stable and known temperature reference may be known at some distance from the reference coils 31. For instance, if the reference coils 31 and the reference temperature measurement 48 are located on different sides of the packer 46, the temperature measurement at 48 may not correspond directly with the true temperature of the reference coils 31. In such cases, a thermal model may be used to determine the temperature differential between the reference coils and the known temperature such that the reference coil temperature can be determined. This model may take as input a number of measured and known parameters, such as flow rate, thermal conductances, changes in fluid paths, and fluid properties to calculate this temperature differential.

The method of using a temperature model to extrapolate temperature data can also be used irrespective of the reference coil 31. When there is a discontinuity in the fiber, such as at a connector or splice (or combinations of these), the losses at the Stokes and Anti-Stokes wavelengths may differ. If the DTS does not correct for this discrete differential loss, the resultant temperature profile will contain a step. Knowing the temperature below the discontinuity allows the step change in the temperature profile to be removed by subtracting the temperature error. The model may be used to infer the temperature below the discontinuity and then correct the DTS profile. Other circumstances when the temperature model may be used to correct the DTS profile include when the flow path diameter has a sudden change (such as with stingers and liners) and the temperature before or after the sudden change must be inferred.

Because the attenuation in the region of interest 30 is relatively small, the dynamic range of the measured signal is smaller than would be required if monitoring the full loop (in the double-ended configuration of FIG. 6). This allows the DTS to be optimized for readings with similar signal strength.

Through the described system configuration, the temperature of the reference coil 31 is kept close to the temperature of the region of interest 30. This allows scaling errors in the observed temperature to be kept small. Any temperature change measured will more accurately represent the actual temperature differential than would be the case if there were large differences between the reference coil 31 temperature and the temperature in the region of interest 30.

A significant advantage of the present invention is a shorter optical path (with lower attenuation) in double-ended configuration. In the double-ended system, backscattering is only measured from the first reference coil 31A, down through the region of interest 30 and back up the fiber to the second reference coil 31B in the fiber. System losses are now therefore only based on losses from the DTS instrumentation 12 through the first reference coil 31A and to the top of the second reference coil 31B. Losses from the second reference coil 31B back to the DTS instrumentation 12 are not included in the calculation of system loss, as would be the case if the reference coils 31 were located in or proximate to the DTS instrumentation 12. Thus, the optical power sent through the optical fiber 14 may be raised without saturating the relevant receiver in the DTS instrumentation 12 and the gain can also be raised without saturating the analog to digital converter in the DTS instrumentation 12.

Another advantage of the system is the time spent on acquisition and sampling of the measurement is only applied to the zone of interest. This allows improved temperature resolution to be obtained in an equivalent or shorter sampling time when compared to acquiring a temperature profile along the full length of fiber. This is of particular importance when the actual downhole temperature may be rapidly changing, such as during a well clean up on initial flow from the well.

Furthermore, the reduced system loss allows additional fiber to be placed in the zone of interest, for example by coiling the fiber rather than placing the fiber in a linear path along the zone of interest. This allows a better spatial resolution across the zone of interest. Should improved spatial resolution not be required, this method allows spatial averaging to achieve improved temperature resolution.

FIG. 8 shows another embodiment in which the subsea well is relatively shallow and the DTS instrumentation 12 is sited on the seabed 32 (or alternatively on a platform) and includes a relatively long interconnection to the wellhead 36. One example is in subsea borehole drilled for research, exploration, and eventually production of methane hydrate. In this embodiment, the interconnection to the well is thermally linked to the water at the seabed and a part of the interconnecting cable 72 may be used as the reference coil 31. The seawater temperature beyond the first few hundred meters is known to be stable and can be verified with additional sensors in the DTS instrumentation 12, at the wellhead 36, or indeed down the well. An additional benefit of the invention in this embodiment is a reduction in the total losses of the loop (in the loop configuration), since reference coils 31 internal to the instrumentation are unnecessary and the cable 72, which is required for interconnecting purposes, also serves as the temperature reference.

Application 2

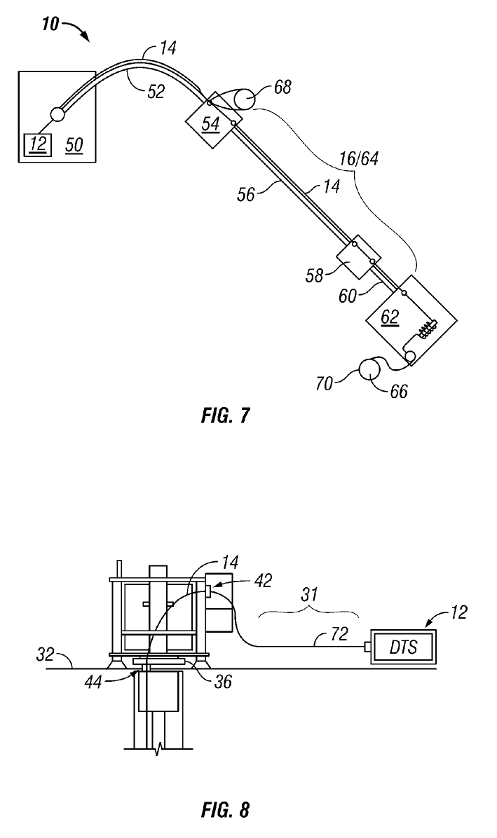

FIG. 7 illustrates the application of the present invention for flow assurance in pipelines, such as subsea pipelines. In this application, the desired point of measurement or region of interest 16 may be some distance from the location of the DTS instrumentation 12, especially if such instrument is located on a surface host facility 50 such as a platform or floating production storage and offloading installation.

Although FIG. 7 illustrates the use of the present invention in subsea pipelines, it is understood that the invention may be used with any pipeline.

Turning to FIG. 7, a subsea flow line monitoring application is shown in the figure above where the DTS instrumentation 12 is located on the host facility 50. The path of the optical cable 14 that is functionally connected to the DTS instrumentation 12 is along the riser section 52 to the riser base 54 along a pipeline 56, across the termination assembly 58, over a jumper 60 and onto the Christmas tree 62. The zone of interest 64 is from the riser base 54 up to and including the Christmas tree 62. The distance between the DTS instrumentation 12 on the installation 50 and the start of the zone of interest 64 can be relatively large.

The fiber optic path can be a single fiber 14 (as shown in FIG. 7), or a dual fiber from the DTS instrumentation 12 connected in a loop configuration through a splice at the far end 66. This loop configuration is similar to that previously described.

The accuracy of the data is important in ensuring the temperature of hydrocarbons does not enter the wax or hydrate formation zone. In order to achieve the desired accuracy, a temperature reference coil 68 is placed in thermal contact with the seawater. The temperature of the seawater may be assumed or measured by a discrete sensor. A second reference coil 70 may be located at the far end 66.

In non-subsea pipeline applications, the temperatures of the reference coils are measured by the methods previously described.

By keeping the measured zone short (between the reference coils 68 and 70), the dynamic range of the DTS 10 is lower than if measuring the full loop, thereby allowing more accurate measurement within the zone of interest 16/64. For a given accuracy, the DTS instrumentation 12 may also be placed further from the zone of interest 16/64 allowing more flexibility in system design.

Application 3

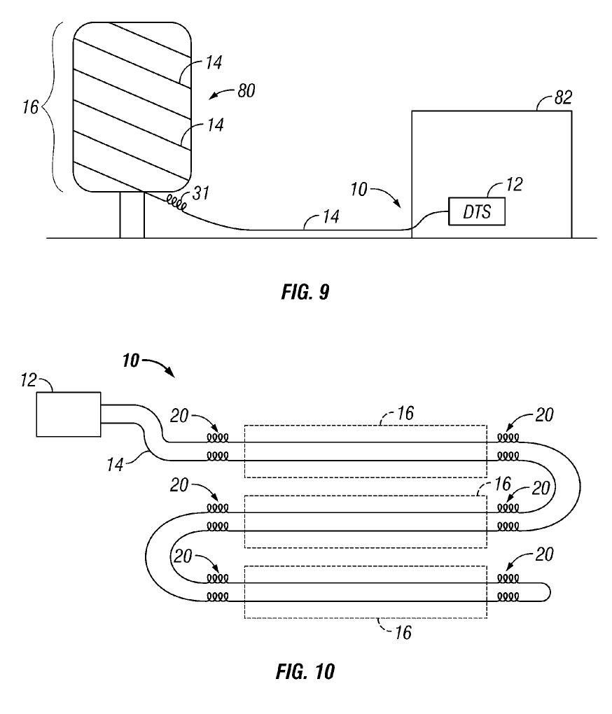

As shown in FIG. 9, the sensing optical fiber 14 of the DTS 10 in this application and embodiment is placed in thermal contact with a structure 80 to be monitored (for example wrapped around a process vessel to measure its skin temperature) and the instrumentation 12 is sited remotely from the structure 80, such as in a control room 82. In sites of this nature, the control room 82 is frequently remote from the process to be monitored in order to avoid electrical power near hazardous areas. In these types of applications, the measurement time is often critical and, in particular, the time required to detect the formation of a small, rapidly growing hot spot. It is therefore desirable to focus the available measurement resources (acquisition time, processing capacity, laser output) onto the section of fiber of interest (that which covers the measurement location 16).

In the conventional approach, the entire length of the optical fiber 14 is measured in order to be able to relate the temperature of the sensing fiber to that of the reference coils located internal to the DTS instrumentation 12. Another factor which must be considered in this application is that the fiber loss in the sensing fiber is frequently quite high owing to tight bends of the fiber, splices required for repairs, or to simplify the installation and possible degradation of the fiber owing to the high temperatures to which it is exposed.

In the present invention, remote reference coils 31 are placed near the structure (vessel) 80 and used to determine the temperature of the sensing fiber 14. In turn, the temperature of the reference coils 31 is determined with an independent, single point sensor in contact with the reference coils 31. Alternatively, the temperature of the reference coils 31 may be measured as previously described (see description in relation to FIGS. 2-4).

This approach has several benefits. First of all, the reference coils 31 may be designed to have sufficient thermal mass that they can be considered to be stable and thus measured only infrequently. Second, given that the reference coils 31 generally have much longer lengths than the resolution required in the sensing fiber 14 (typically 50 to 200 meters versus 1 meter spatial resolution), the spatial averaging which may be used in the determination of the reference coil 31 temperature allows a far better accuracy than could be achieved with the spatial resolution required in the sensing fiber 14. Third, the task of measuring the dynamic range of the entire loop (if a loop configuration is used) is broken down into at least two steps, namely from the control room 82 to the remote reference coils 31 and the sensing loop between the reference coils 31 and including the sensing fiber 14 across the region of interest.

Given that the cost of interconnecting cable is generally very low and in particular that the cost of placing additional fibers in the cables is even lower, it may be preferred to use a second fiber loop to monitor the interconnecting cable and the remote reference coil (instead of using a separate sensor). Certain of the commercially available DTS systems allow multiple fiber loops to be measured with a single instrument 12. One of the benefits of using separate fiber loops is that the length of the fiber in the remote reference coil may be different for the two loops and optimized independently.

Other Applications

The present invention may also be used to monitor transmission transformers (where a high voltage location requires the DTS instrumentation 12 to be distant from the region of interest), a nuclear storage facility (where safety concerns require the instrumentation 12 to be distant from the region of interest), power cables and power lines (where distance may require the instrumentation 12 to be distant from the region of interest).

While the invention has been disclosed with respect to a limited number of embodiments, those skilled in the art, having the benefit of this disclosure, will appreciate numerous modifications and variations therefrom. It is intended that the appended claims cover all such modifications and variations as fall within the scope of the invention.

What is claimed is:

1. An optical fiber distributed temperature sensing system, comprising:
an opto-electronic unit and an optical fiber functionally connected to the opto-electronic unit;
the opto-electronic unit adapted to transmit optical energy into the optical fiber and to receive backscattered signals reflected from the optical fiber in order to measure temperature;
the optical fiber including at least one reference coil at a known temperature; and
the reference coil located remote from the opto-electronic unit.

2. The system of claim 1, wherein the optical fiber is deployed in a subterranean wellbore.

3. The system of claim 2, wherein the at least one reference coil is located in the wellbore.

4. The system of claim 2, wherein the wellbore is a subsea wellbore.

5. The system of claim 1, wherein the temperature at the reference coil is measured by a separate sensor.

6. The system of claim 1, wherein the temperature at the reference coil is measured by a separate optical fiber functionally connected to the opto-electronic unit.

7. The system of claim 1, wherein the temperature at the reference coil is measured by the optical fiber with an optical pulse having unique characteristics.

8. The system of claim 1, wherein the temperature at the reference coil is measured by use of a thermal model.

9. The system of claim 1, wherein the optical fiber is deployed along a pipeline.

10. The system of claim 9, wherein the pipeline is a subsea pipeline.

11. The system of claim 1, wherein the optical fiber is deployed on a structure.

12. The system of claim 11, wherein the structure is a process vessel.
